(19) United States
(12) Patent Application Publication
(10) Pub. No.: US 2016/0372079 A1
(43) Pub. Date: Dec. 22, 2016

(54) PERSONALIZED COLOR DISPLAY SYSTEM THROUGH BIG DATA ANALYSIS AND METHOD THEREOF

(71) Applicant: Duk Gwan Ku, Chungcheongnam-do (KR)

(72) Inventor: Duk Gwan Ku, Chungcheongnam-do (KR)

(21) Appl. No.: 14/741,506

(22) Filed: Jun. 17, 2015

(51) Int. Cl. G09G 5/02; G06T 7/40; G06F 17/22

(52) U.S. Cl. CPC G09G 5/02; G06F 17/22; G06T 7/408; G09G 2320/0666; G09G 2320/08

(57) ABSTRACT

A personalized color display system through big data analysis and a method thereof are provided. The personalized color display system includes a providing unit configured to provide a document including a color code according to at least one object, a collection unit configured to collect log data of users, which flow in through the document, and response information about the object, and an analysis unit configured to analyze color information associated with a specific user using the log data and the response information. When the document is provided to the specific user, the providing unit changes a color code of the object to the color information associated with the specific user.

### BACKGROUND

Embodiments of the inventive concepts described herein relate to technology for providing user-customized information through big data analysis.

Recently, as high-speed Internet networks have been installed throughout the country, the Internet has been the backbone of all activities of people. The Internet has been used in all activities necessary for daily lives of people, such as a search service, electronic commerce (e-commerce), or a financial service as well as transmission of files or electronic mail (e-mail).

In addition, as people have been interested in leisure activities, a variety of contents which allow the people to enjoy leisure activities have been provided. Recently, a personalized contents providing service which provides contents such as various information or advertisements suitable for users through their communication terminals has been operated.

### SUMMARY

Embodiments of the inventive concepts provide a personalized color display system for combining user responses with big data analysis and displaying user-customized information to which colors suitable for individuals are applied and a method thereof.

Embodiments of the inventive concepts provide a personalized color display system for combining color response information to which anthropological characteristics of users and personal taste or mental states are reflected and for providing affective contents according to personalized colors and a method thereof.

One aspect of embodiments of the inventive concept is directed to provide a personalized color display system through big data analysis. The personalized color display system may include a providing unit configured to provide a document including a color code according to at least one object, a collection unit configured to collect log data of users, which flow in through the document, and response information about the object, and an analysis unit configured to analyze color information associated with a specific user using the log data and the response information, wherein when the document is provided to the specific user, the providing unit changes a color code of the object to the color information associated with the specific user.

The log data may include a visitor log collected through a Java script tracking code in an open source analytic service and a visitor log directly collected from a web server of the personalized color display system, with respect to the document.

The analysis unit may obtain a personalized color of the specific user by analyzing a color code of objects, to which the specific user responds and analyzing a color code of objects, to which other users of a group associated with the specific user.

The providing unit may reflect a complementary color of the color information associated with the specific user to a color code of a peripheral region of the object.

The providing unit may reflect a color code corresponding to a time zone to a background color of the document according to the time zone when the document is provided.

The document may be a mirroring document provided from another service. The providing unit may provide an index for the document to a search engine to guide users to flow in using the document.

Another aspect of embodiments of the inventive concept is directed to provide a personalized color display method through big data analysis, which is implemented by a computer. The personalized color display method may include providing a document including a color code according to at least one object, collecting log data of users, which flow in through the document, and response information about the object, analyzing color information associated with a specific user using the log data and the response information, and when the document is provided to the specific user, changing a color code of the object to the color information associated with the specific user and providing the changed color information.

### BRIEF DESCRIPTION OF THE FIGURES

The above and other objects and features will become apparent from the following description with reference to the following figures, wherein like reference numerals refer to like parts throughout the various figures unless otherwise specified, and wherein

FIG. 1 is a drawing illustrating a personalized color display environment through big data analysis according to an exemplary embodiment of the inventive concept;

FIG. 2 is a drawing illustrating a big data collection and analysis environment according to an exemplary embodiment of the inventive concept;

FIG. 3 is a flowchart illustrating a personalized contents providing service method according to an exemplary embodiment of the inventive concept;

FIG. 4 is a block diagram illustrating a configuration of a personalized color display system according to an exemplary embodiment of the inventive concept;

FIG. 5 is a flowchart diagram illustrating a personalized color display method according to an exemplary embodiment of the inventive concept; and

FIG. 6 is a drawing illustrating a method of applying user-customized colors to a document according to an exemplary embodiment of the inventive concept.

### DETAILED DESCRIPTION

Embodiments will be described in detail with reference to the accompanying drawings. The inventive concept, however, may be embodied in various different forms, and should not be construed as being limited only to the illustrated embodiments. Rather, these embodiments are provided as examples so that this disclosure will be thorough and complete, and will fully convey the concept of the inventive concept to those skilled in the art. Accordingly, known processes, elements, and techniques are not described with respect to some of the embodiments of the inventive concept. Unless otherwise noted, like reference numerals denote like elements throughout the attached drawings and written description, and thus descriptions will not be repeated. In the drawings, the sizes and relative sizes of layers and regions may be exaggerated for clarity.

It will be understood that, although the terms “first”, “second”, “third”, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the inventive concept.

Spatially relative terms, such as “beneath”, “below”, “lower”, “under”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” or “under” other elements or features would then be oriented “above” the other elements or features. Thus, the exemplary terms “below” and “under” can encompass both an orientation of above and below. The device may be otherwise oriented (rotated 90 degrees or at other orientations) and the spatially relative descriptors used herein interpreted accordingly. In addition, it will also be understood that when a layer is referred to as being “between” two layers, it can be the only layer between the two layers, or one or more intervening layers may also be present.

The terminology used herein is for the purpose of describing particular embodiments only and is not intended to be limiting of the inventive concept. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Also, the term “exemplary” is intended to refer to an example or illustration.

It will be understood that when an element or layer is referred to as being “on”, “connected to”, “coupled to”, or “adjacent to” another element or layer, it can be directly on, connected, coupled, or adjacent to the other element or layer, or intervening elements or layers may be present. In contrast, when an element is referred to as being “directly on,” “directly connected to”, “directly coupled to”, or “immediately adjacent to” another element or layer, there are no intervening elements or layers present.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

Hereinafter, a description will be given in detail for exemplary embodiments of the inventive concept with reference to the accompanying drawings.

Exemplary embodiments of the inventive concept relate to technology for providing user-customized information through big data analysis, and more particularly, to a personalized color display system for providing affective contents according to user-customized colors and a method thereof.

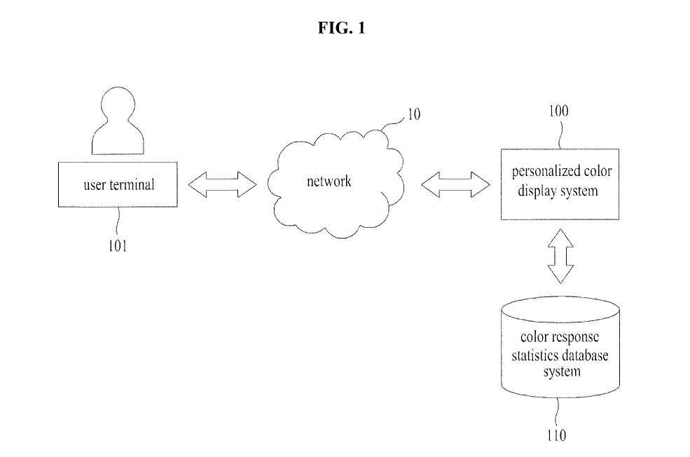

FIG. 1 is a drawing illustrating a personalized color display environment through big data analysis according to an exemplary embodiment of the inventive concept.

FIG. 1 illustrates a user terminal 101, a personalized color display system 100, and a color response statistics database system 110. In FIG. 1, arrows mean that data may transmit and receive between elements using a wired/wireless network 10.

The user terminal 101 may mean at least one of all terminals, each of which connects to web/mobile sites associated with the personalized color display system 100 or installs and executes a service dedicated application. In this case, the user terminal 101 may perform an overall operation of services, such as a service screen configuration service, a data input service, a data transmission and reception service, and a data storing service, under of control of a web/mobile site or a service dedicated application.

For example, the user terminal 101 may include, but is not limited to, at least one of an Internet television (TV), a personal computer (PC), a notebook computer, a laptop computer, a smartphone, a tablet computer, or a wearable computer, and the like.

The user terminal 101 may be directly or indirectly coupled to the network 10 (e.g., the Internet or a local area network, and the like). For example, a PC and a notebook computer may be directly coupled to the network 10 through wired connection. A laptop computer may be wirelessly coupled to the network 10 through a wireless communication channel established between the laptop computer and the wireless access point (WAP). A smartphone may be wirelessly coupled to the network 10 through a wireless communication channel established between the smartphone and a cellular network/bridge.

In this case, the network 10 may communicate with one or more secondary networks (not shown). For example, the second networks may include, but is not limited to, at least one of a local area network, a wide area network, or an intranet.

The user terminal 101 may interface with the personalized color display system 100 through the above-described network 10.

The personalized color display system 100 may play a role as a service platform which provides a personalized contents providing service which provides user-customized information to the user terminal, which is a client, through big data analysis.

The personalized color display system 100 may execute one or more processes configured to perform one or more of characteristics described in the specification.

Particularly, the personalized color display system 100 may combine user responses with big data analysis and may provide affective contents according to personalized colors of a user.

The personalized color display system 100 may collect big data associated with Internet activity information. In this case, the personalized color display system 100 may analyze the collected big data to obtain statistics information about color responses, and may construct the database system 110 by recording this statistic information. Therefore, the personalized color display system 100 may identify a color suitable for the user according to statistics information on the database system 110, and may provide user-customized information using the identified color.

The personalized color display system 100 may correspond to a server computer. For example, the server computer may include, but is not limited to, at least one of a server computing device, a PC, a server computer, a series of server computers, a mini-computer, and/or a main frame computer. The server computer may be a distributed system, and operations of the server computer may be performed simultaneously and/or successively on one or more processors.

The personalized color display system 100 may be implemented with, but is not limited to, a device included in a service platform which provides a personalized contents providing service in a client-server environment. The personalized color display system 100 may be also implemented with an application which may be installed and executed on the user terminal 101.

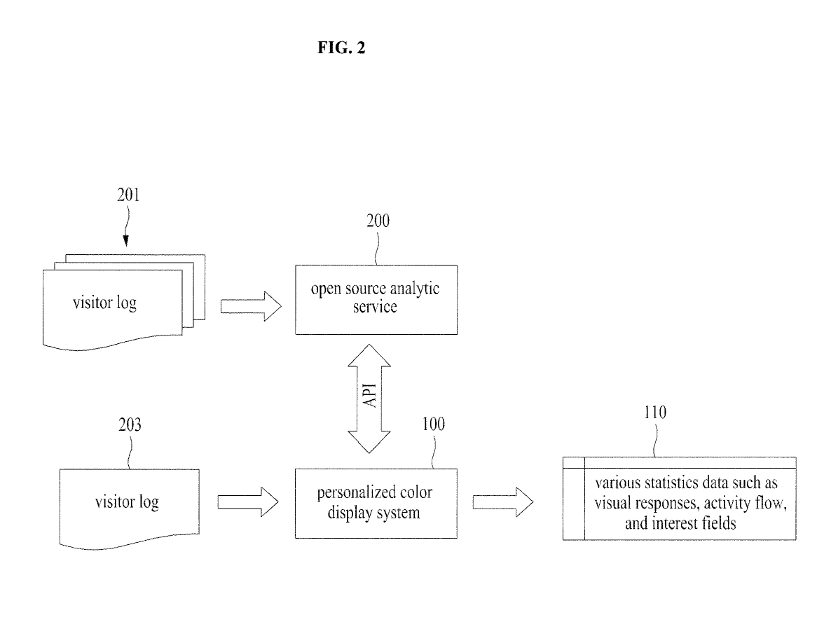

FIG. 2 is a drawing illustrating a big data collection and analysis environment according to an exemplary embodiment of the inventive concept.

A personalized color display system 100 may obtain real-time analysis information about big data including activity information on the Internet of users through an open source analytic service 200.

In the open source analytic service 200, visitor logs 201, including all activity information (e.g., information about objects clicked by users, and the like) of users who visit a variety of Internet sites such as a search service (e.g., Google, Naver, and the like), an encyclopedia service (e.g., Wikipedia, and the like), a social network service (e.g., Facebook, and the like), and a shopping service (e.g., Amazone, and the like), may be collected through a visitor log collection code based on Java script. Visual responses, activity flow, interest fields, ages, jobs, languages, education levels, and the like of users, which flow in various sites, may be analyzed from the visitor logs 201. In other words, in the open source analytic service 200, information about all users who act on the Internet may be analyzed in real time.

The personalized color display system 100 may directly collect a visitor log 203 which flow in through a web/mobile site or a service dedicated application which is connection with the personalized color display system 100, in addition to analysis information obtained from the open source analytic service 200, and may analyze information of service users in real time through the collected information.

Accordingly, the personalized color display system 100 may collect big data about activity information on the Internet with respect to all users who use the Internet by combining a real-time visitor log with open source analytic information, and may obtain various statistics data 110 such as visual responses, activity flow, and interest fields of Internet users may be obtained by analyzing the collected big data.

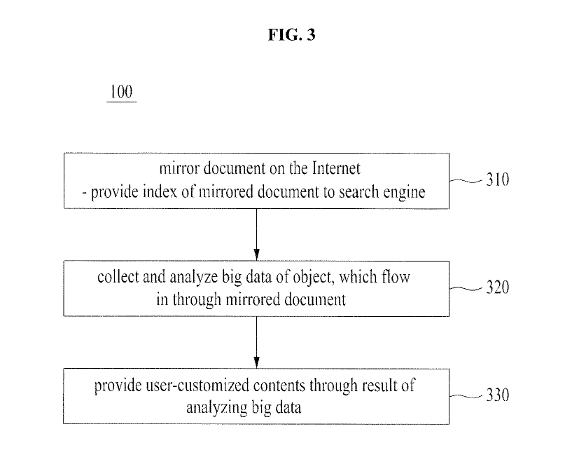

FIG. 3 is a flowchart illustrating a personalized contents providing service method according to an exemplary embodiment of the inventive concept. Respective steps of a personalized contents providing service method according to an exemplary embodiment of the inventive concept may be performed by a personalized color display system 100 shown in FIGS. 1 and 2.

In step 310, the personalized color display system 100 may mirror a document of another service, which is opened on the Internet through donating hosting of the other service. The document may mean all data which are an object to be searched for by a search engine. The document may include structured data such as database (DB) and may also include unstructured data, such as web data on blog or bulletin board, as an object to be searched for.

For example, the personalized color display system 100 may link data on an online encyclopedia service (e.g., Wikipedia, and the like) to a variety of paths through donating hosting and may provide the linked data to the whole world.

For this, the personalized color display system 100 may provide an index of a document, which is an object to be mirrored, to a search engine (e.g., Google, Naver, and the like). Herein, the document may be provided as a searched result by a search engine. In addition, the document may be freely posted and spread through a social network service (e.g., Facebook and the like).

The personalized color display system 100 may guide visitors to flow in through the document provided as the searched result by the search engine or the document posted on the social network service (e.g., Facebook and the like), and the like.

In step 320, the personalized color display system 100 may collect data of an object, which flow in through the mirrored document, and may analyze interest information big data of a corresponding visitor.

The personalized color display system 100 may analyze interest information in real time from link click responses of users, which flow in through the mirrored documents, and may prepare basic data for target marketing.

Statistics results through the big data analysis may include age groups, sex, areas, interest fields, used communication devices, user behavior analysis, user click distribution, and the like of visitors.

In step 330, the personalized color display system 100 may provide user-customized contents according to the result of analyzing the big data. The personalized color display system 100 may provide contents or information suitable for users according to information included in the result of analyzing the big data.

Colors may be the most important element as visual communication media. However, there may be individual different preference for colors according to areas, ages, inclination, feelings, and the like. In consideration of this point, the personalized color display system 100 may transmit a personalized color, in which colors suitable for individuals are combined, as a visual message to a user through a display and may adjust mental responses of the user through the visual message to guide a desired result.

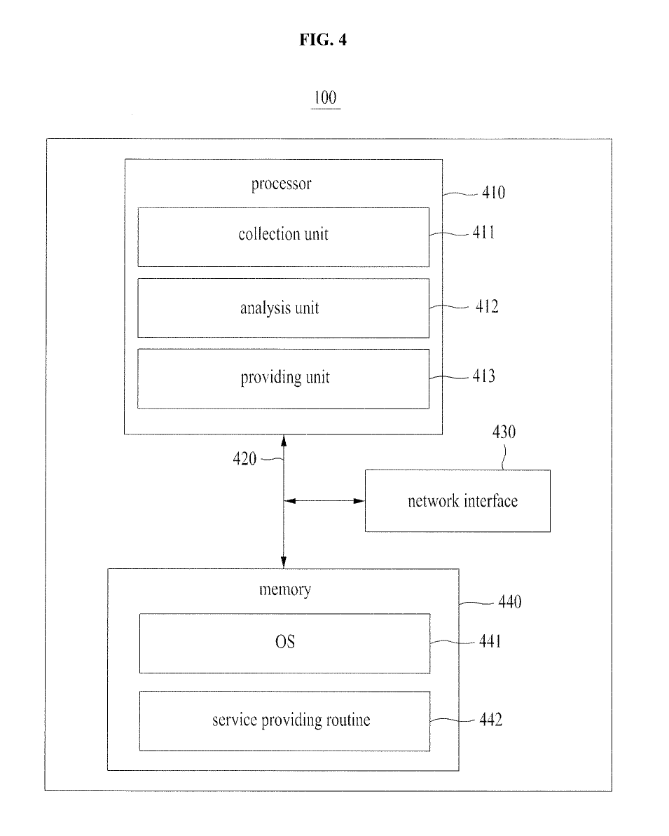

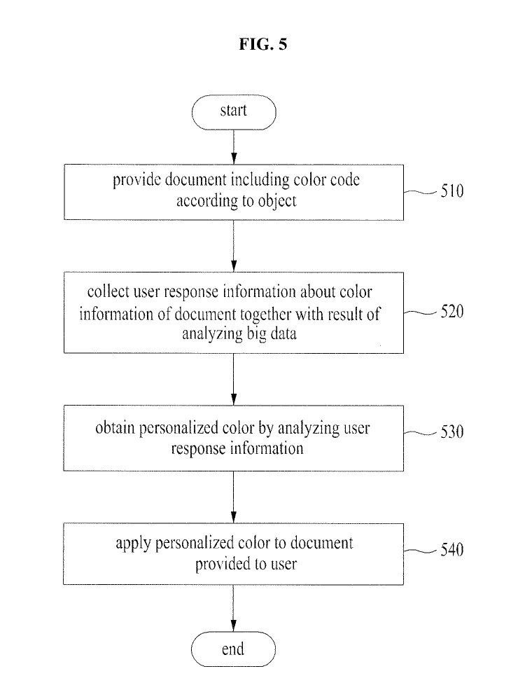

FIG. 4 is a block diagram illustrating a configuration of a personalized color display system according to an exemplary embodiment of the inventive concept. FIG. 5 is a flowchart diagram illustrating a personalized color display method according to an exemplary embodiment of the inventive concept.

As shown in FIG. 4, a personalized color display system 100 according to an exemplary embodiment of the inventive concept may include a processor 410, a bus 420, a network interface 430, and a memory 440. The memory 440 may include an operating system (OS) and a service providing routine 442. The processor 410 may include a collection unit 411, an analysis unit 412, and a providing unit 413. The personalized color display system 100 according to other exemplary embodiments of the inventive concept may further include more elements than those of FIG. 4.

The memory 440 may be a computer-readable medium, and may include permanent mass storage devices such as a random access memory (RAM), a read only memory (ROM), and a disc drive. Also, the memory 440 may store program codes for the OS 441 and the service providing routine 442.

These software elements may be loaded from a computer-readable medium, which is separately provided from the memory 440, using a drive mechanism (not shown).

This separate computer-readable medium may include at least one of computer-readable media (not shown) such as a floppy drive, a disc, a tape, a digital versatile disc/compact disc (CD)-ROM (DVD/CD-ROM) drive, and a memory card.

In another exemplary embodiment of the inventive concept, software elements may be loaded into the memory 440 through the network interface 430 rather than a computer-readable medium.

The bus 420 may facilitate communication and data transmission between elements of the personalized color display system 100. The bus 420 may be configured using a high-speed serial bus, a parallel bus, a storage area network (SAN), and/or other suitable communication technologies.

The network interface 430 may be a computer hardware element for connecting the personalized color display system 100 to a computer network. The network interface 430 may connect the personalized color display system 100 to the computer network through wireless or wired connection.

The processor 410 may be configured to process an instruction of a computer program by performing a basic arithmetic and logic operation and an input and output operation of the personalized color display system 100

The instruction may be provided to the processor 410 through the bus 420 by the memory 440 or the network interface 430.

The processor 410 may be configured to execute a program code for the collection unit 411, the analysis unit 412, and the providing unit 413. This program code may be stored in a storage device such as the memory 440.

The collection unit 411, the analysis unit 412, and the providing unit 413 may be configured to perform steps 510 to 540 of a personalized color display method which will be described below with reference to FIG. 5.

In step 510, the providing unit 413 may provide a document including color codes (e.g., red, green, and blue codes) when providing the document to service users. The document may be made by entering color codes in the document according to respective objects (e.g., photos, writing, and the like) corresponding to elements displayed on a display. Color codes for a background color of a document and a peripheral color of an object as well as an object color may be entered in the document, respectively.

In step 520, the collection unit 411 may collect user response information about color information of the document with respect to service users who use the document. For example, the collection unit 411 may collect click information by service users with respect to an object having a color code in the document.

Also, the collection unit 411 may collect a real-time visitor log through a Java script tracking code in an open source analytic service and may collect a real-time log through an access internet protocol (IP), an access time, a visiting page, and the like in the server itself. In this case, the collection unit 411 may collect a result of analyzing basic information including a position, sex, an age group, and the like of a corresponding visitor from a result of analyzing an open source through an access IP, an access time, a visiting page, and the like among the collected log data.

In step 530, the analysis unit 412 may analyze user-customized color information according to the result of analyzing the big data and the user response information. In case of objects, such as photos and writing, clicked by users while the users use a service, the analysis unit 412 may obtain color codes of objects which have user responses by recognizing color code values entered in the corresponding objects.

For example, the analysis unit 412 may obtain a color suitable for a corresponding user by analyzing color codes of an object to which the user previously responds (e.g., an object previously clicked by him or her) or analyzing color codes of an object to which service users of a group (e.g., the same sex, the same age group, the same interest field, and the like) associated with the user respond.

In step 540, the providing unit 413 may apply a personalized color of a corresponding user to a document provided to the specific user. In other words, the providing unit 413 may change a color code of an object included in the document to a user-customized color.

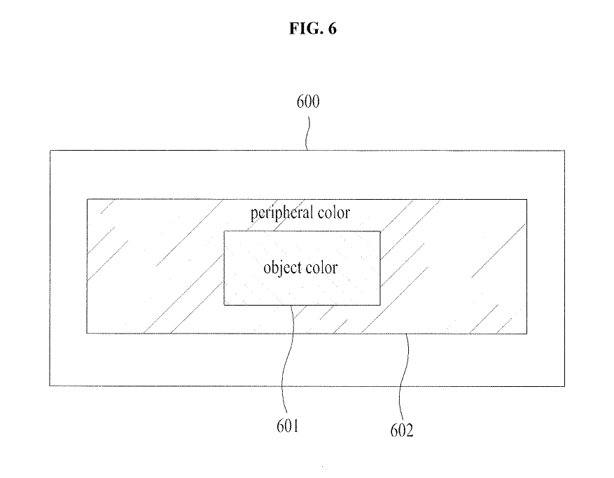

FIG. 6 is a drawing illustrating a method of applying user-customized colors to a document according to an exemplary embodiment of the inventive concept.

Referring to FIG. 6, when a document 600 including at least one object 601 is provided to a user, a providing unit 413 of FIG. 4 may change a previous color code of the object 601 to a personalized color associated with the user.

Also, the providing unit 413 may apply a complementary color of the user-customized color reflected to the object 601 in the document 600 to a color code of a peripheral region 602 of the corresponding object 601.

Also, the providing unit 413 may change a background color of the document 600 according to an access time of the user. By way of an example, the providing unit 413 may define 10-step colors between black and white and may match step-by-step colors with time zones. The providing unit 413 may apply a color corresponding to an access time of the user to a background color of the document 600. By way of another example, the providing unit 413 may previously define corresponding background colors according to color codes for the object 601 (e.g., when an object color is green, a background color is gray). The providing unit 413 may apply a user-customized color to the object 601 and may simultaneously reflect a background color corresponding to a color of the object 601 to the document 600.

Therefore, the personalized color display system and method according to exemplary embodiments of the inventive concept may combine the user response information with the result of analyzing the big data and may display the document with colors suitable for individuals.

The document to which colors individuals prefer are applied is described as a representative example of user-customized information according to the big data analysis. The scope and spirit of the inventive concept may not be limited thereto.

By way of an additional exemplary embodiment of the inventive concept, a personalized color display system may play a role as an art contents service platform.

In more detail, the art contents service platform may digitalize works (e.g., paintings, photos, sculptures, and the like) of an artist and may provide the digitalized information as affective contents to the public through websites, social network services (SNSs), offline public relations, and the like. In addition, the art contents service platform may play a role as an art contents hub which distributes income through on-line/off-line to an artist.

Awareness of an artist or work may be enhanced through this art contents service platform. Visitors may be guided to flow in using art contents. Art contents as affective contents suitable for users may be also provided through real-time big data analysis for art contents.

The above-mentioned personalized color display method may include shorter operations or additional operations according to details of the personalized color display system shown in FIGS. 1 to 6. Also, two or more operations may be combined with each other, and orders or positions of operations may be changed to each other.

As such, according to exemplary embodiments of the inventive concept, the personalized color display system may provide a personalized color which has high preference for each individual by combining user responses with big data analysis and displaying colors suitable for individuals.

Therefore, the personalized color display system may propose new targeting technology using personal preference for colors and may provide affective contents which may adjust mental responses by reflecting a personalized color to a document provided to users.

The methods according to exemplary embodiments of the inventive concept may be implemented with program instructions which may be performed through a variety of computer systems and may be recorded in computer-readable media. Also, a program according to an exemplary embodiment of the inventive concept may be configured with a PC-based program or a mobile terminal dedicated application.

The above-described devices may be realized by hardware elements, software elements and/or combinations thereof. For example, the devices and components illustrated in exemplary embodiments of the inventive concept may be implemented in one or more general-use computers or special-purpose computers, such as a processor, a controller, an arithmetic logic unit (ALU), a digital signal processor, a microcomputer, a field programmable array (FPA), a programmable logic unit (PLU), a microprocessor or any device which may execute instructions and respond. A processing unit may implement an operating system (OS) or one or software applications running on the OS. Further, the processing unit may access, store, manipulate, process and generate data in response to execution of software. It will be understood by those skilled in the art that although a single processing unit may be illustrated for convenience of understanding, the processing unit may include a plurality of processing elements and/or a plurality of types of processing elements. For example, the processing unit may include a plurality of processors or one processor and one controller. Alternatively, the processing unit may have a different processing configuration, such as a parallel processor.

Software may include computer programs, codes, instructions or one or more combinations thereof and may configure a processing unit to operate in a desired manner or may independently or collectively control the processing unit. Software and/or data may be permanently or temporarily embodied in any type of machine, components, physical equipment, virtual equipment, computer storage media or units or transmitted signal waves to be interpreted by the processing unit or to provide instructions or data to the processing unit. Software may be dispersed throughout computer systems connected via networks and may be stored or executed in a dispersion manner. Software and data may be recorded in one or more computer-readable storage media.

The methods according to the above-described exemplary embodiments of the inventive concept may be implemented with program instructions which may be performed through various computer means and may be recorded in computer-readable media. The computer-readable media may also include, alone or in combination with the program instructions, data files, data structures, and the like. The program instructions recorded in the media may be designed and configured specially for the exemplary embodiments of the inventive concept or may be known and available to those skilled in computer software. For example, computer-readable media may include magnetic media such as hard disks, floppy disks, and magnetic tape; optical media such as CD-ROM disks and DVDs; magneto-optical media such as floptical disks; and hardware devices that are specially configured to store and perform program instructions, such as read-only memory (ROM), random access memory (RAM), flash memory, and the like. For example, program instructions may include both machine code, such as produced by a compiler, and high-level language code that may be executed by the computer using an interpreter. The described hardware devices may be configured to act as one or more software modules to perform the operations of the above-described exemplary embodiments of the inventive concept, or vice versa.

While a few exemplary embodiments have been shown and described with reference to the accompanying drawings, it will be apparent to those skilled in the art that various modifications and variations can be made from the foregoing descriptions. For example, adequate effects may be achieved even if the foregoing processes and methods are carried out in different order than described above, and/or the aforementioned elements, such as systems, structures, devices, or circuits, are combined or coupled in different forms and modes than as described above or be substituted or switched with other components or equivalents.

Therefore, other implements, other embodiments, and equivalents to claims are within the scope of the following claims.

What is claimed is:

1. A personalized color display system through big data analysis, comprising:
a providing unit configured to provide a document including a color code according to at least one object;
a collection unit configured to collect log data of users, which flow in through the document, and response information about the object; and
an analysis unit configured to analyze color information associated with a specific user using the log data and the response information,
wherein when the document is provided to the specific user, the providing unit changes a color code of the object to the color information associated with the specific user.

2. The personalized color display system of claim 1, wherein the log data include a visitor log collected through a Java script tracking code in an open source analytic service and a visitor log directly collected from a web server of the personalized color display system, with respect to the document.

3. The personalized color display system of claim 1, wherein the analysis unit obtains a personalized color of the specific user by analyzing a color code of objects, to which the specific user responds and analyzing a color code of objects, to which other users of a group associated with the specific user.

4. The personalized color display system of claim 1, wherein the providing unit reflects a complementary color of the color information associated with the specific user to a color code of a peripheral region of the object.

5. The personalized color display system of claim 1, wherein the providing unit reflects a color code corresponding to a time zone to a background color of the document according to the time zone when the document is provided.

6. The personalized color display system of claim 1, wherein the document is a mirroring document provided from another service, and
wherein the providing unit provides an index for the document to a search engine to guide users to flow in using the document.

7. A personalized color display method through big data analysis, which is implemented by a computer, comprising:
providing a document including a color code according to at least one object;
collecting log data of users, which flow in through the document, and response information about the object;
analyzing color information associated with a specific user using the log data and the response information; and
when the document is provided to the specific user, changing a color code of the object to the color information associated with the specific user and providing the changed color information.
